(19) United States
(12) Patent Application Publication
(10) Pub. No.: US 2002/0120837 A1
(43) Pub. Date: Aug. 29, 2002

(54) Distributed internet multicast system for the stock market

(76) Inventors: Nicholas Frank Maxemchuk, Mountainside, NJ (US); David Hilton Shur, Holmdel, NJ (US)

Correspondence Address: BANNER & WITCOFF, 1001 G STREET N W, SUITE 1100, WASHINGTON, DC, 20001, US

(21) Appl. No.: 09/794,112

(22) Filed: Feb. 28, 2001

(51) Int. Cl. H04L 9/00

(52) U.S. Cl. 713/153

(57) ABSTRACT

A distributed architecture for a future global Internet stock exchange utilizes a modified timed Reliable Multicast Protocol comprising geographically distributed backbone nodes and trading nodes regionally connected to backbone nodes so that multicast messages are received at the same time in a two tier distribution network. The architecture together with a timed reliable multicast protocol has characteristics such as periodic token passing appropriate for the market data distribution application so that trading sites are equally treated by the protocol. The protocol is modified/enhanced to provide time synchronous emission of data and improved scalability. Grades of service may be provided as between nodes which comprise trading nodes and individuals receiving data from such nodes.

### BACKGROUND OF THE INVENTION

1. Technical Field

This invention relates to the field of multicast information systems and, more particularly, to a system and method for 1) fairly transmitting market information to users of a market information service, 2) receiving buy and sell offers from potential users at an electronic exchange or collection of exchanges such that all users have equal access to the electronic exchange and 3) treating the collection of electronic exchanges as a single, globally distributed electronic trading floor replacing separate exchanges.

2. Description of the Related Arts

An exchange is any organization, association or group which provides or maintains a marketplace where securities, options, futures or commodities can be traded. There are hundreds of exchanges around the world. Yahoo lists over one hundred stock exchanges in their directory of stock exchanges. Traditionally, an exchange was located in a single physical place, for example, in New York, Philadelphia, London or Paris. Electronic exchanges allow remote traders to connect electronically to “computer exchanges”. In the past, connectivity was achieved via dedicated access lines and private networks, which were expensive, and thus limited who could be connected. The Internet now allows or is on the verge of allowing almost anyone who wants to, to connect via the Internet to almost any electronic exchange in any country at very low cost. Internet communication technology is enabling restructuring of stock and other forms of exchanges. Large numbers of private “trading floors” are emerging on the Internet, and a large amount of stock trading is taking place within these exchanges.

Traders need up-to-date and current information to make trades and should have equal access to a trading floor. Yet, there presently exists no means for providing a distributed multicast or personal trading system via the Internet or other communications medium. Anyone should be able to trade anywhere at any time, exercising trades in as close to real time as possible and parallel trades as I close to simultaneously as possible without the fear that they have not received available information in as timely a manner as possible or other individuals will have greater opportunity to reach the exchange faster.

Referring to FIG. 1, an original reliable broadcast protocol RBP was designed in the early 1980's in order to build a distributed database on an Ethernet. FIG. 1 shows a number n of message Sources where a given source s is between 1 and n. Each source, for example, Source s, is shown having transmitted Mₛ messages via a Broadcast Medium BM to a Token Loop TR comprising m Receivers, numbered 0 to m−1. A token is passed among globally distributed Receivers and, at a given point in time, may be located at Token Site TS, the r^{th} receiver.

The original protocol had the following three distinguishing characteristics: every Receiver places the messages from all of the Sources in the same sequence; when a message is successfully received, there is only one acknowledgement Ack t, that is, one control message per source message, independent of the number of receivers; and every receiver eventually knows that every other receiver has the message.

The basic Reliable Multicast Protocol (Multicast replacing Broadcast in the title) or RMP protocol is straightforward. There is also a more complicated reformation phase, based upon a three phase commit, that is followed when new Receivers join or leave the multicast group of Receivers in token loop TR, not to be confused with a conventional token ring used, for example, in local area networks (LAN). In a conventional distributed market data multicast application according to FIG. 1, easy access to the group is not permitted, and the three phase commit protocol will not be considered.

There are n sources and m receivers. The sources and receivers may be different in total number and characteristic. The objective is for every receiver to correctly receive and order every message from all n sources in the same order. This characteristic significantly simplifies building a distributed database. A key characteristic of the RMP protocol is that when there are no data losses that require retransmissions, there is only one control message per data message from the source, independent of how many receivers there are. If there are packet losses, then there will be proportionally additional control/retransmission messages.

The message from Source s contains the label (s, Mₛ) that signifies that this is the Mₛ th message that Source s has transmitted. A Source s multicasts a message using a simple positive acknowledgement protocol. Specifically, the Source s will periodically transmit message Mₛ, and will continue transmitting message Mₛ at regular intervals until it receives an acknowledgment, or decides that the receivers are not operating.

At any instant in time, one receiver r has the responsibility for acknowledging messages from sources. The receiver r with the responsibility is called the token site TS. Each receiver takes a turn at being the token site and passes the token to the next receiver in logical sequence. Each of the receivers is assigned a unique number from 0 to m−1. When the token site TS at receiver number r, where r is between 0 and m−1, sends an acknowledgement, the control message is multicast and serves four separate functions: 1) It is an acknowledgement to sources s that message (s, Mₛ) has been received by the group of Receivers in token loop TR; 2) It informs all of the receivers that message (s, Mₛ) is assigned the global sequence number t; 3) It is an acknowledgement to the previous token site, r−1 mod m, that the token was successfully transferred to receiver r; 4) It is a message to the next token site, receiver [r+1] mod m, inviting it to accept the token. These are examples of functionality provided in a token loop of RMP as distinguished from a conventional token ring.

Token site r periodically sends acknowledgement t until it receives acknowledgement t+1, which acknowledges that receiver [r+1] mod m accepted the token. If an acknowledgement isn't received in a specified number of attempts, receiver r decides that receiver r+1 is inoperable and initiates a reformation process. In order to prevent unnecessary reformations, receiver r+1 transmits a token acknowledgement message when there are no source messages to acknowledge.

As soon as r sends acknowledgement t it gives up the right to acknowledge new source messages, even though it is not certain that [r+1] mod m has received the token. This guarantees that at most one receiver assigns sequence numbers to source messages.

Receiver [r+1] mod m to accept the token does not accept the token transferred by acknowledgement t until it has all of the acknowledgements and source messages that were acknowledged up to and including t. Once a receiver accepts the token it responds to all retransmission requests.

The receivers use a negative acknowledgement protocol and explicitly request retransmissions. If an acknowledgement is received with a larger sequence number than expected, the receiver requests the missing acknowledgements. If an acknowledgement is received for a source message (s, Mₛ) that has not been received, the receiver requests retransmission of the missing source message.

The sources and previous token sites use a positive acknowledgement protocol and implicitly request retransmissions. If a source retransmits a message that has been acknowledged, the implication is that the source failed to receive the acknowledgement. If a previous token site retransmits a token passing message, the implication is that the site failed to receive the token passing acknowledgement.

When a receiver passes the token, it does not stop servicing retransmission requests until it receives the acknowledgement for passing the token. This guarantees that at least one site can respond to all retransmission requests.

RMP guarantees that every receiver eventually receives the acknowledged messages and that every receiver eventually knows that every other receiver has received these messages. When a source message is acknowledged, the receiver that sent the acknowledgement has that message and all of the acknowledged source messages that preceded it. We can also infer that the previous token sites had all of the messages that were needed to accept their latest token. Therefore, when acknowledgement t is transmitted from receiver r:

receiver r has all of the messages up to and including the t^{th} source message,

receiver (r−1) mod m has all of the messages up to and including the (t−1)^{th} source message,

. . . , and

receiver (r−m+1) mod m has all of the messages up to and including the (t−m+1)^{th} source message.

Since (r−m) mod m=r, all of the receivers have all of the messages up to and including the (t−m+1)^{th} source message.

A similar line of reasoning allows us to determine what all receivers know about the other receivers. When the t^{th} acknowledgement is transmitted receiver r knows that all of the receivers have all or the messages up to and including (t−m+1)^{th} source message. As before,

receiver (r−1) mod m knows that all receivers have all of the messages up to and including the (t−m)^{th} source message,

. . . , and

receiver (r−m+1) mod m knows that all of the receivers have all of the messages up to and including the (t−m+2)^{th} source message.

Since (r−m) mod m=r, all of the receivers know that all of the receives have all of the messages up to and including the (t−m−+2)^{th} source message.

It can take a long time to recover missing messages in an event driven system that uses negative acknowledgements. When there are no new source messages to acknowledge, receivers that missed the latest source messages or acknowledgements do not detect their loss.

Referring again to FIG. 1, the token site TS also maintains a list L_{A}, 1 . . . t, of the recent messages that have been acknowledged and the last acknowledgement that was sent. (All depicted receivers are shown maintaining a list L_{A} of the recent messages that have been received). The token site TS has a very significant role in the protocol—it is responsible for servicing requests for missing messages or acknowledgements. Like all other receivers, it also has a set of received messages, 1 . . . t. If the next received message s, Mₛ is also in its list L_{A}, the token site TS assumes that source s did not receive the acknowledgement, and resends the corresponding acknowledgement. If (s, Mₛ,) is not in L_{A}, the token site multicasts an acknowledgement. The acknowledgement contains (s, Mₛ,j,Rₜ,Rₙ). The first two entries tells the sₜₕ source that its Mₛ th message has been placed in list L_{A}. The fourth entry identifies the current token site and the fifth entry is a request to transfer the token to receiver Rₙ.

Once a token site TS requests to transfer the token, it stops acknowledging messages, but continues to service requests for missing messages. When a receiver receives acknowledgement j, it checks the last entry in its version of list L_{A}. If the last entry is less than j−1, it requests the missing acknowledgements from the current token site, the oldest first. This request uses a simple acknowledgement protocol. The receiver continues to request the missing acknowledgement until it receives the acknowledgement or decides that the token site has failed.

The receiver processes all received acknowledgements the same, jᵣ is the next value of the token that will be added to the local receiver's list L_{A}. If j<jᵣ, the acknowledgement is already in the receiver's version of L_{A}, it assumes that the acknowledgement is being retransmitted. If there is a copy of the message (s, Mₛ) in its set of received messages, the receiver assumes that the repeated acknowledgement was sent to the original source, and that message is removed from the set of received messages. The duplicate acknowledgement is discarded. If jᵣ>j, there are missing acknowledgements and the receiver requests acknowledgements jᵣ, . . . j−1 from the token site TS. If jᵣ=j, the acknowledgement is the next sequence number expected in L_{A}, the receiver checks to see if message (s, Mₛ) is in the received set. If the message is in the set, the receiver moves the message to the j^{th} position in L_{A}. Otherwise, the receiver requests the missing message from the token site TS, also using a simple acknowledgement protocol.

Token passing in RMP is treated as a positive acknowledgement protocol. Rₜ continues to transmit acknowledgement j until it is certain that Rₙ has accepted the token. Once Rₙ receives the acknowledgement to transfer the token, it does not accept the token until it has recovered any missing acknowledgements or messages in L_{A}. It cannot accept the token until this time because part of the responsibility of the token site is to service requests for missing messages or tokens. The token can be accepted implicitly or explicitly. A site implicitly accepts the token by acknowledging a message. If the current token site has acknowledged message j, and sees any acknowledgement for a message >j it assumes that the next site has accepted the token and tried to forward it. If Rₙ does not have any messages to acknowledge, or has already transferred the token when it receives acknowledgement j, it sends an explicit message to Rᵣ that Rₙ accepts the token.

Each time the token is forwarded, we are certain that one more site has received a previously acknowledged message. Therefore, there is a tradeoff between delay and the number of sites that have received the message. In addition, if site k acknowledges message j, the next time that it receives the token, it is certain that every other receiver in the token list has received message j, when the token passes around the list a second time, site k not only knows that every receiver has received message j, but that every site knows that every other site has received message j.

If there are no new messages to acknowledge, it may be a long time before a site that missed the last message and acknowledgement realizes it. To prevent this from happening, the token site TS transfers the token after k seconds if it does not have any messages to acknowledge.

The original protocol referred to broadcast groups, rather than multicast groups, because the work preceded the coining of the word multicast. RBP previously applied to the Internet, has recently been renamed the RMP (multicast) protocol. NASA maintains a WEB site of recent work on this protocol and a list of companies that deliver products that use the RMP protocol. However, it is believed that there remains a need to extend the capabilities of RMP for certain applications and, in particular, there remains a need in the art for an improved data network for equity and other market data distribution. RMP cannot operate effectively to deliver a stock ticker or treat all traders with fair access to an exchange because a network with millions of receivers must pass the token millions of times before the reception guarantees are realized; when receivers join or leave a group frequently, the original reformation process will spend most of its time reorganizing the receiver list, rather than ordering messages, and most messages will be lost by some receivers so that the number of recovery messages may eliminate the advantages of the small number of control messages generally required in RMP.

### SUMMARY OF THE INVENTION

These and other disadvantages of applying the present RMP in a global environment of exchanges where each exchange is separately accessed are overcome by the principles of the present invention. According to the principles of the present invention, a globally distributed architecture and timed protocol can be used both to construct individual exchanges and also enables the fair interconnection of individual electronic exchanges. The distributed architecture of the present invention has a number of important advantages such as lower cost, and greater fault tolerance/reliability, compared to traditional centralized approaches. Also the architecture allows individual exchanges to maintain their own identity, and setup bilateral agreements with other exchanges, without the need to be subservient to a single “super” exchange.

An objective of the present invention is to provide communications services for a distributed system of traders without dictating or limiting the rules under which they do business. For instance, we may wish to have the communications systems providing such services present bids from a large number of traders, world wide, to a dozen trading floors, simultaneously, in the same order. The communications system should not limit how a trade is performed, what credentials are required, or which buyers and sellers are matched up. While we focus on stock exchanges in the following description of a preferred embodiment, many of the ideas and concepts disclosed herein are applicable to other types of exchanges.

A distributed multicast system comprises a plurality of backbone nodes comprising, for example, primary sources and primary receivers, operating in accordance with a timed reliable multicast protocol for communicating with one another. The backbone nodes, comprising primary sources and primary receivers, are globally distributed and comprise a global multicast tree. The nodes may be physically connected via any known arrangement but are logically connected in a token loop arrangement (not to be confused with a conventional token ring). A relatively few number of primary receivers may together comprise a primary token loop using the timed reliable multicast protocol. Secondary receivers may form a secondary token loop with at least one primary receiver of a primary token loop. A secondary token also may use the timed reliable multicast protocol of the present invention. Any receiver may be a transmitter or source of messages but may not necessarily be so.

A plurality of at least one trading node is connected to a proximate backbone node, a trading node comprising a trading server for trading stock in response to an electronic transfer message associated with one of stock or funds representing a stock trade value. Finally, a plurality of individual users comprise at least one individual receiver connectable to one proximate secondary receiver in one local multicast tree for a given region and another individual connectable to another proximate secondary receiver in another local multicast tree in another region, multicast messages being multicast to selected ones of said individuals and selected ones of said trading nodes in accordance with the hierarchical primary and secondary token loop architecture. However, the local multicast trees operate utilizing, for example, a conventional RMP protocol or a gossip protocol known in the art. Reformation servers are provided for reforming a token loop for a primary or secondary token loop that fails.

While the present invention is described in the context of an underlying Internet protocol (IP) multicast capability, TRMP may also be utilized in an underlying network that is not IP multicast enabled, for example, a network having an “application layer” multicast capability wherein servers communicate using conventional IP unicast. An IP unicast enabled server of such a network receiving a given data stream will replicate the stream and forward the stream to neighboring servers forming a distribution tree in a manner similar to IP multicast. In this embodiment, clients access the data by connecting to such a server. Such “application layer” multicast networks are presently deployed by Akamai, Digital Island and AT&T among others, using servers and equipment manufactured by Intomi, RealNetworks, Microsoft, NetworkAppliance and Cacheflow, among others.

For appreciating the following detailed description of a preferred embodiment and understanding for terminology that may appear in the appended set of claims to our invention, we define the following terms:

A trading floor is any location or medium where stocks are bought and sold. It may be a physical place where stock certificates are exchanged for currency, an Internet site where electronic stock certificates are exchanged for electronic funds transfers, or a communications group with rules for how buyers and sellers are matched up. For instance, in an efficient electronic auction a seller may offer “n” shares of stocks to the highest bidder above “x” dollars, the buyers may submit closed bids with their highest offer, and the stocks awarded to the highest bidder at the price offered by the second highest bidder. Alternatively a buyer may offer to buy “n” shares at a price of “x” dollars or below. Or, the bidding may proceed in steps as in a conventional auction or perhaps like the flower auctions in the Netherlands.

A trader is anyone who is trusted to buy and sell stocks on a particular trading floor. Traders may be analogous to current stock brokers who are trusted. In a more democratic system, a trader may be any stock owner who has obtained a certificate that he currently owns “x” shares of a stock or any buyer who has obtained a certificate worth “y” dollars.

An individual is anyone who wants to receive information about stocks or wants to buy or sell stocks via a trader or on a trading floor.

A ticker is defined as a merged stream of part of all of the buy and sell offers of a trading system. Some trading floors may generate their own ticker, while others use a ticker provided by another trading floor.

A source is a source of information or data and a receiver is a recipient of information or data delivered from a source. There may be primary sources logically connected to a primary source token loop following the timed reliable multicast protocol and secondary information sources. For example, the primary sources may trust a set of primary brokers and a secondary source may trust a set of customers with information. There similarly may be primary receivers logically connected to a primary receiver token loop following the timed reliable multicast protocol and secondary receivers connected to a secondary receiver token loop, in turn distributing information to a customer receiver via a local multicast tree.

A global multicast tree is used to logically couple primary sources, reformation servers and primary receivers. At least one primary source is associated with several secondary sources in a secondary source token loop. At least one primary receiver is associated with several secondary receivers in a secondary receiver token loop.

An acknowledgement message provides an indication that a given event occurred and a negative acknowledgement is an indication that a given event did not occur such as whether a given message has been received.

A multicast tree originates at a source and comprises branches to intermediate receivers of a multicast message until received at all destination receivers and includes the destination receivers.

### BRIEF DESCRIPTION OF THE DRAWING

FIG. 1 shows a conventional application architecture for the original reliable broadcast (multicast) protocol.

FIG. 2 is a system diagram of a distributed multicast architecture for a stock market according to the present invention incorporating a timed reliable multicast protocol.

FIG. 3 provides an extended finite state machine representation of acknowledgement processing in accordance with a timed reliable multicast protocol of the present invention.

### DETAILED DESCRIPTION OF A PREFERRED EMBODIMENT

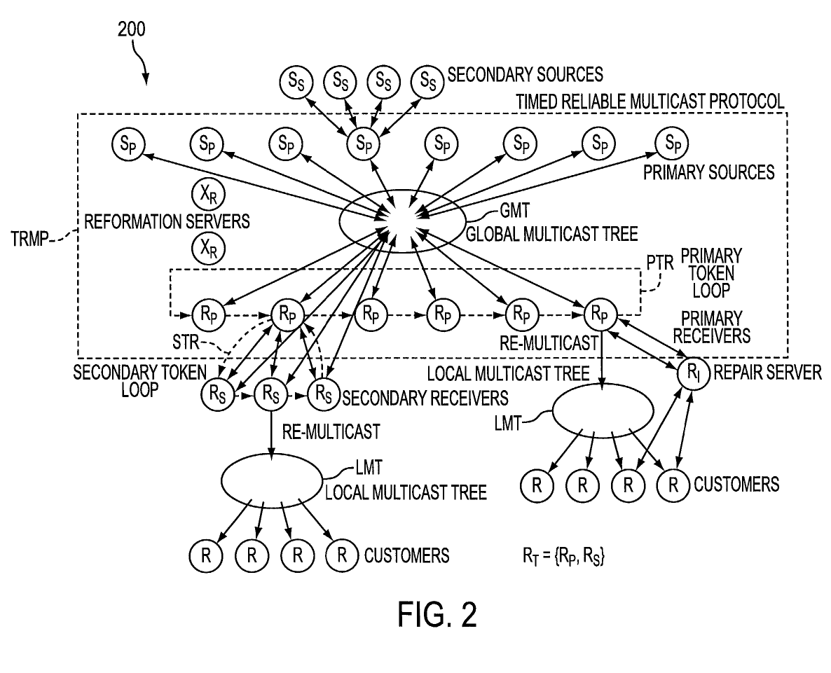

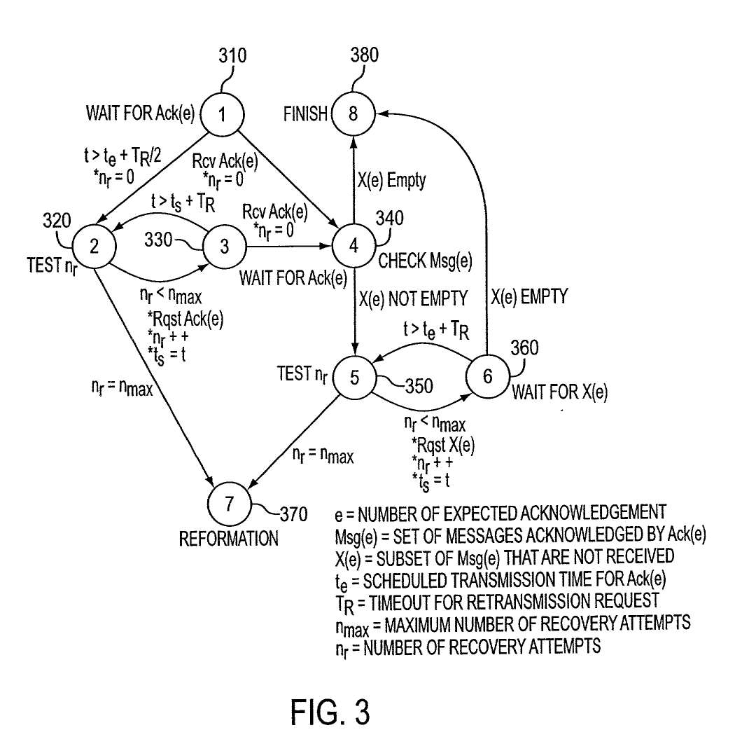

Referring to FIG. 2, there is shown a system diagram of a distributed multicast architecture for a stock market according to the present invention recognizing that the present distributed architecture may likewise be employed for any exchange but is described herein with respect to the purchase of stocks or other equity securities. Referring to FIG. 3, there is shown an extended finite state machine representation of acknowledgment processing in accordance with a timed reliable multicast protocol (TRMP) for use in the proposed architecture of FIG. 2 and in accordance with the present invention. The architecture of FIG. 2 using a timed reliable multicast protocol promotes information delivery fairness and trading fairness for all individuals trading in a collection of exchanges. While TRMP will be described in the context of a network assuming the existence of an underlying Internet Protocol (IP) multicast capability, the present invention should not be deemed to be limited to IP multicast, and any underlying network may be utilized so long as a multicast capability exists, for example, an “application layer” multicast capability.

The following data may pass within and through the system 200 of FIG. 2: all buy and sell offers from all individuals, for example, Customers having Receivers R, all buy and sell offers from all traders, and time ordered lists of all of the trades made on several trading floors that are spread around the world, among other data. Note that the buy and sell offers may pertain to equity securities of any kind including securities, futures, options, etc. Sources and receivers may be connected to one another in practically any physical sense but are logically connected according to FIG. 2. Also, 2s FIG. 2 should not be deemed to be limited as any depicted receiver may be a message source or transmitter and any depicted source may be a receiver.

Traditional stock exchanges have been centralized. All data (both market and trades) flows through a centralized system, for example, via a central site. The centralized system is also responsible for transaction reporting and also settlements for the purposes of exchanging assets. The use of private electronic networks like the NASDAQ and also the Internet have allowed remotely located traders and users to connect with the centralized system and participate in trading.

We propose a distributed trading architecture as per FIG. 2, where the centralized system or central site may be replaced by a distributed system architecture. For the purpose of regulation, transaction reporting, settlements and the like may continue to be done by a centralized site according to the present invention, but the presence of a central site, for example, one of the Primary Sources or Receivers, is not required. The transmission of market data and trades is distributed according to the present invention via a backbone network, comprising all the dotted line area TRMP.

Consider a “network backbone”, consisting of a set of backbone nodes distributed globally. The trading nodes, which may comprise a source or receiver, are not connected to a central site; according to the present invention, trading nodes, connect to the closest backbone node in the backbone network. For example, a trading node may be a globally distributed trading node located in Birmingham, United Kingdom and may be connected to its closest backbone node located in London. The backbone nodes all execute a timed reliable broadcast protocol (or multicast protocol) which includes a time synchronization protocol, so that all backbone nodes release the same data to associated trading nodes at the same time. The reliable broadcast protocol is such that, if any node, either backbone node or trading node fails, the distributed system 200 continues to function. In the event of message loss in the system 200, messages are recovered from other nodes, either backbone or trading node, in an orderly fashion, so all backbone nodes see the same message sequence.

There are different data requirements in distributed system 200 depending on who is the intended recipient of the data. A plurality of possible end recipients R (who may be data generators) is shown. End-customers, individuals who buy and sell stock for their own use, typically connect to Internet based trading companies (e.g., Datek, First Trade, etc.). These users get a feed consisting of the current (or slightly delayed—anywhere from 30 seconds to 20 minutes) trade information. Detailed trade information, namely the sequence of trades for a particular stock, may also be provided, as well as bid and ask quotes. It is also possible and known to provide for display a “ticker-tape” stream of financial symbols that represent stocks, bonds, mutual funds, commodities, and their latest trading prices. Perfect reliability (guaranteed delivery of this information) is not required, because information is refreshed by the next trade of that security. On the other hand, when an end-customer places an order to buy or sell, that transaction should have guaranteed and timely delivery. An actual trade must be perfectly reliable.

Traders in financial institutions have stricter requirements on data feed delivery. Reliability and timeliness are needed for all data, as a missed trade is a missed opportunity to buy or sell. Low latency is required (one second or less) since the asking price may alter on a time scale of seconds. Simultaneity of delivery is very important because feeds should be delivered to all recipients without anyone achieving an advantage through early delivery. There may be security and privacy requirements.

Consequently, the present invention solves these problems via the combined concepts of providing a timed reliable protocol and distributing nodes as described in FIG. 2 to equalize the fairness of data delivery among end recipients.

In an electronic exchange, traders which may comprise one or more of individuals R coupled to system 200 connect to a common network and send and receive information, trades, etc., via computer applications. Trading companies and brokerage houses are increasingly providing their own electronic front-end and trading systems. We will refer to these systems which are within system 200 as trading nodes. These nodes connect in turn to the common backbone network nodes which will be referred to herein as Primary Sources or Primary Receivers. The common network 200 may be accessed by private lines, and access via the Internet in secondary networks.

An increasing number of Internet based private stock trading systems are emerging. Users access these systems via the Internet using WWW browsers. A typical private stock trading system consists of a logical WWW server (which may be composed of one or more physical servers) which interface into other trading systems such as the NASDAQ. The private stock trading systems may satisfy buy and sell requests among their own subscriber base, or may pass on the trade to the larger exchanges such as NASDAQ.

According to Frank G. Zarb, Chairman and CEO National Associate of Securities Dealers Inc., in a very few years, trading securities will be digital, global, and accessible 24 hours a day. People will be able to get stock price quotations instantly and instantly execute a trade anytime of day or night, anywhere on the globe, with stock markets linked and almost all-electronic. Trading floors and paper, for the most part, will be rendered obsolete by competition and technology. Investors will use not only their home or office computers, but also will commonly use cellular phones, pagers, and palm-sized computers to access the markets on the Internet, get price quotes, and execute trades through their brokers.

Investors will even be able to get programmable computerized reports on the performance of their personal investments through their car radios while driving to and from work. At the office or at home, they will be able to get the same information broadcast to them on a digital TV.

All of this will be available in an orderly, fair, well-regulated, and lower-cost environment, with improved high-tech electronic surveillance of trading to protect the integrity of the markets.

As for stock markets, they will see global alliances, mergers, and new electronic ventures. That will give companies listed on these markets access to pools of capital internationally, not just domestically, and consumers will be able to invest in a worldwide list of companies as easily as trading locally.

This 21st century stock market will be multi-dealer, computer-screen based, technology-driven and open to all—all because people will have access to information that they want to act on.

This new market will bring benefits to inventors, listed companies, and the economies of countries. Trading will cost less for customers. Markets will have more liquidity. Raising capital for companies will be easier and more efficient. Entrepreneurial businesses in both established and developing economies will be encouraged. New investors and markets will grow in places like China. Investors from Europe to Japan to the Americas will invest across borders with ease.

The distributed architecture of FIG. 2 meets these requirements and forecasts.

The following are requirements of the distributed architecture of FIG. 2: timelines—all trading nodes should receive market data at the same time with minimal delay (say within a second of the actual generation of the data in the system); fairness—no trading node should receive data before any other trading node; authentication—unauthorized access should be prevented; security security of transactions is significant for Internet access; fault tolerance—the system should continue functioning even in the event of a catastrophic local failure; global reach—the system should have global reach (there may be traders in 100's of countries in every continent. All of these requirements may be met by the distributed architecture of FIG. 2.

The RMP Protocol and Our Proposed TRMP Protocol

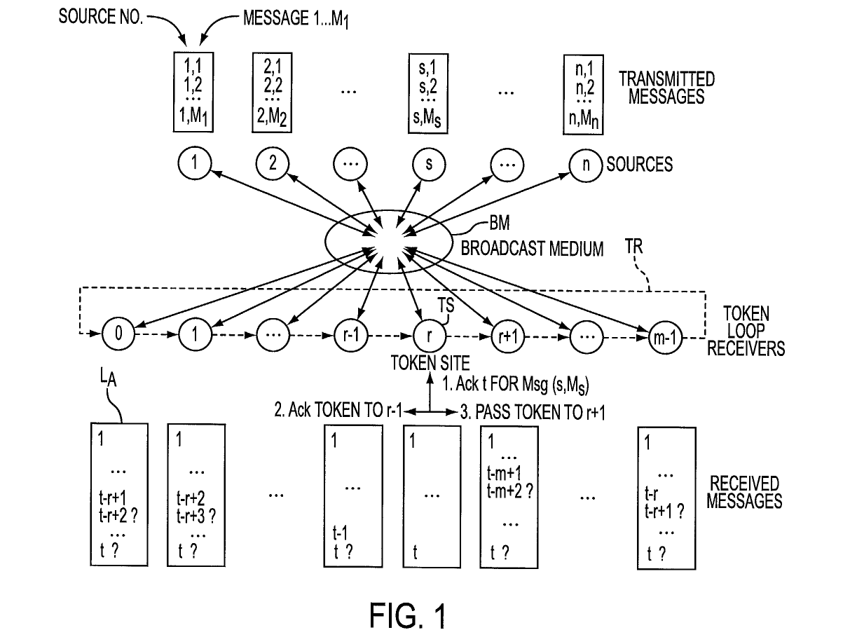

The original reliable broadcast protocol (FIG. 1) was not designed to operate in the Internet environment with large numbers of correlated losses and potentially large number s of receivers. In addition, the application described above for providing a reliable data broadcast and distribution for market data adds new requirements. In particular, the correct message sequence should be provided to all of the receivers at the same time, and there is a trade-off between timeliness and correctness. There are also security issues—for example, authentication is required, and encryption may be needed.

There are several differences between a known distributed database application and the stock market that suggests changes in the conventional RBP/RMP protocol.

The first change is the number of receivers. There are a lot more recipients of a stock ticker than there are storage sites in a distributed database. This suggests a two or more level hierarchy as shown in FIG. 2. There are a few tens or possibly of the order of a hundred primary sources or receivers in a Timed Reliable Multicast Protocol according to the present invention. Primary sources and receivers are spread around the world. Associated with each one of these primary sources and receivers is a region. Acknowledgement j is time stamped, with time tⱼ when it is first sent. At time tⱼ+T, or after delay T, each TRMP receiver re-multicasts the message that was acknowledged, within its own region. The original messages are either encrypted with a key that only the RBP receivers can decrypt, or are multicast in a private network that the network provider does not allow unauthorized receivers to listen to. Therefore, message j is not available to any of the customers until tⱼ+T.

The delay makes it possible to deliver most of the messages to all of the customers at the same time, even though there may be a number of retransmissions. The larger we make delay T, the more likely that a receiver has the RMP message when he is scheduled to retransmit it. Therefore, there is a trade-off between completeness and delay.

Consequently, each receiver (or source) of the present invention may comprise a known processor, data receiver (or transmit) operably coupled to a media that may be fiber or cable or wireless, a buffer memory and a synchronous clock. The customers who listen to the RMP re-multicasts can be offered different grades of service. They can listen to the unreliable stream from the local RMP receiver, or they can insist upon being able to request missing messages in that stream. The lower grade of service is probably adequate for a stock ticker, and one RMP receiver can support an unlimited number of customers, since it doesn't make any difference how many receivers listen to the multicast. The higher grade of service will probably be useful to brokerage houses who also research stocks based upon all sales. There is a cost per customer associated with servicing retransmission requests, although the retransmission may also be multicast. Any one of several reliable multicast protocols may be employed within the region, depending on its size/geographical spread and the number of receivers. Our proposal is to use TRMP in a global multicast tree and RMP or other protocol regionally.

Another difference between the stock market and database applications is the number of messages. We expect a lot more messages in the stock market application. Instead of sending one acknowledgement per message, it may be worthwhile sending an acknowledgement and token passing message, periodically, or every τ second. The periodic acknowledgement would be used to acknowledge a list of messages that the token site has in its received set, rather than a single message. In addition, since the system is scheduled to send a control message every τ second the trade off between completeness and delay can be more precise. Since an RMP receiver can detect missing acknowledgements from the time since the last acknowledgement, a receiver does not have to wait until a good acknowledgement is received before trying to recover missing acknowledgements (acks). This will increase the probability that a receiver obtains message j before time tⱼ+T.

We have considered a number of examples:

### EXAMPLE 1

As a starting point, to show what communications services can be provided, we will hypothesize the following system that uses the multicast group to provide a merged ticker for the trading floors:

There are 10's of trading floors, 1,000's of traders, and 1,000,000's of stock owners.

The trading floors can operate differently. Some may be physical places, others may be an Internet servers, and still others may be communications protocols that are used in a multicast group. Some trading floors may only allow registered brokers to buy and sell stocks, others may allow anyone who can prove ownership of the stock or the validity of their credit in any way that the floor decides to accept. Different trading floors may place different limits on the minimum or maximum size transactions.

The rules and risks associated with the different trading floors are known. It is also useful to consider system architecture as distinct from the protocols that operate within the architecture. For example, reliable protocols other than RBP/RMP exist or could be invented for a local region. The distributed architecture we describe could be beneficial in these cases as well. For the purposes of concrete explanation, and because the RBP/RMP protocol has properties which are desirable in the stock exchange environment, we will focus exclusively on RMP/RBP.

An RMP group is a grouping of stock exchange data, such that the number of messages in the group is not excessive with respect to what most receivers can handle. All of the trading floors report every trade that is transacted in an RMP group. Each trading floor encrypts its messages with a different secret key that it shares with the RMP receivers. The shared secret identifies the message as coming from the trading floor and keeps individuals from eavesdropping on the RMP group to gain early information on the ticker.

The RMP group places the messages in the same order at every RMP receiver. At time t−1, a message is first acknowledged, it is decrypted by each RMP receiver, then re-encrypted with a key that legal recipients purchase, as described subsequently, and multicast in a local multicast group (for example, a brokerage house network).

Most individuals buy the low grade service and cannot request missing messages—which can be identified by missing RMP sequence numbers. Most individuals will want to track a small number of individual stocks, not necessarily the entire merged ticker. The traders and certain individuals may buy a high-grade service and can request the retransmissions of any message that they miss. These messages may be multicast if they are missed by many sites, and thereby also made available to low grade receivers,—or encrypted with a second key that is only available to those who pay more.

Individuals who want to buy or sell stocks can view the ticker, then, decide which trading floor they would like to deal on. Depending on the trading floor, they would either contact a broker, or obtain the necessary credentials and trade for themselves.

### EXAMPLE 2

As a second example we use the RBP/RMP to construct a distributed, international trading floor as a timed communications protocol TRMP.

The buyers and sellers in this protocol may be individuals, brokers/traders, or the other trading floors. The TRMP trading and backbone nodes are located around the world to give buyers and sellers equal access, independent of their location. Sellers make offers to sell so many shares of a stock above a minimum price by sending a message to the local RBP group or withdraw or change earlier offers.

Buyers make bids to buy so many shares of stock below a maximum price by sending a message to the multicast group or withdraw or change earlier offers. All offers and bids contain the credentials required by the trading floor, and the participants signature. All of the participants see all of the offers in the same order. Based upon the RBP sequence, an arbiter declares trades to be made when an offer and bid are aligned, and reports the trade on an appropriate trading floor ticker.

General Architecture

Referring to FIG. 2, internationally—tens of backbone nodes take part in the timed RBP/RMP protocol TRMP at least in a primary token loop PTR. These nodes belong to the network provider and can be trusted not to favor specific customers. These TRMP nodes are geographically spread over the entire world as equally as possible and preferably have multicast capability, or example, IP multicast or application layer multicast functionality colocated at the node. There is, for example, one or two nodes per region, where a region may be a continent. This backbone layer receives inputs from all of the trading floors internationally, and puts them in the same order at every TRMP node. The nodes try to keep the token moving at “k” nodes per second. After “1/k” second, or what is left of that time after the token is received, the TRMP node acknowledges any messages that it has, or passes the token with no acknowledgements. “n/k” seconds after a message is acknowledged, all of the TRMP nodes multicast the messages that were acknowledged in their own area. The larger we make “n” the more likely that the message is re-multicast at the same time in all of the regions, but the greater the delay. If there is a possibility that receivers can eavesdrop on the RMP nodes, then the messages that enter the system are encrypted with a key that only the RMP nodes can decrypt, and the RMP nodes decrypt the messages when they are re-multicast.

Locally (among trading nodes connected to the same backbone node), one primary node multicasts the messages from the primary TRMP group. A secondary, or more local node, may be one of the TRMP nodes, or it may be part of a regional group LMT if there are too many local receivers to be serviced by a single node. All local nodes multicast the message at about the same time. (It is assumed that all nodes in the hierarchy use a timing protocol such as NTP to keep their clocks synchronized. It is assumed that the timing protocol is sufficient to maintain synchronization to within, for example, about 50 msecs.) Preferably, the messages in the RMP sequence are numbered so that individual receivers can notice missing messages and request retransmissions from their local sources. There can be, for example, two grades of service that are sold. In a lower grade, receivers cannot recover lost sequence numbers, while in the higher grade they can.

A single RMP node can re-multicast to an unlimited number of low grade receivers, but additional recovery servers and link capacity is added to the RMP node when the number of high grade receivers increase beyond certain numbers.

In N. F. Maxemchuk, “Electronic Document Distribution”, ATT Technical Journal, vol. 73, no. 5, Sept. 1994, pg 73-80, there is provided an example of how to use encryption in a multicast group so that there is only one encryption for the entire group, but members of the group are discouraged from giving away the key because they also have to give away their personal credit card number of other personal information. That technique may be applied in the multicast market information application discussed here. This technique, however, is only useful for low to moderate cost information because there are ways around it, at a cost. The technique, however, should be adequate, for example, to guard a ticker tape.

The Regional Network

The network of FIG. 2 uses a timed RMP-like protocol to get messages to the local re-multicast nodes at about the same time and with about the same probability as they would have been received at the RMP node if the RMP node were doing the remulticast. Instead of operating on the raw messages from the source, these nodes operate on the message acknowledgements from the RMP sources. When a regional node receives the token, it can recover any messages acknowledged by the token site TS or earlier from the regional node who passed the token site the token. If the regional token node is expecting, and receives ack “i”, before ack “i+1” or greater from the RMP group, the regional token node operates on this ack, if not it requests this ack from its regional RMP representative, who must recover the ack message from the RMP group if it does not have the ack message.

The regional token node operates on the ack from the RMP group by: if it does not have the messages that are acknowledged, it requests those messages from the regional node, who must recover them from the RMP group if it does not have them. Once the regional node has the acknowledgement and messages, it passes the regional token to the next regional node.

Referring to FIG. 2, the modified architecture of the present invention is multi-layered and is shown in contrast to the known RBP architecture of FIG. 1. Primary sources, SP, are trusted more than the secondary sources, Sₛ, although the Sₚ may not be completely trusted. The primary sources Sₚ transmit messages on a global multicast tree GMT. The global multicast tree for receiving data from sources for distribution to multiple destination receivers may be overlaid on any data network of servers having a multicast capability including IP multicast, application layer multicast and other networks having a multicast capability. The group of primary and secondary receivers R_{T}={Rₚ,Rₛ} are preferably owned by the network. The R_{T} participate in a timed reliable multicast protocol TRMP according to the present invention and are trusted to recover missing messages and to send the messages to all of the customers, R, at the same time. The large numbers of R are not trusted at all. If the quantity of data transmitted in an application exceeds the message handling ability of the R_{T}'s, the entire reliable multicast segment of the architecture may be replicated, as described subsequently.

In the upper layer of the receiver architecture the m receivers Rₚ in the primary token loop PTR use TRMP to recover messages over the long distance segments of the network that have large delays and high loss rates. Herein, we use the term “token loop” to distinguish over conventional token rings. In a TRMP token loop such as primary loop (PTR) data is multicast using an underlying multicast capability such as IP multicast, and sources may transmit when they wish. A TRMP token loop is a mechanism for periodically rotating responsibility for associated control functions of the TRMP protocol, including but not limited to, underlying source acknowledgement, global sequencing, reformation, retransmission and repair services. This TRMP server group forming a token loop should be limited to a few tens of receivers. When there are more recovery points, the logical token loop in TRMP is divided into a primary loop that is intercontinental, and a plurality of secondary token loops STR, including the Rₛ, that cover specified regions of the globe, and possibly tertiary loops that cover more restricted areas. A secondary loop STR must comprise at least one primary receiver. In a multiple loop configuration, TRMP is modified as described subsequently so that each message is assigned a single sequence number.

In the lowest layer of the architecture, we supply the information to a large number of customers R who may join and leave the system frequently. The logical loops in TRMP are not appropriate in this environment since the R cannot be trusted to assist one another and frequent changes in the receiver set require frequent reformations. Instead, the receivers R_{T} delay delivery of messages by a fixed time after they are acknowledged then retransmit the message sequence to the associated receivers R on respective local multicast trees LMT.

In the customer layer of receivers R, the propagation delay is insignificant, the network delays are small, and packets are lost less frequently. The raw remulticast messages may be sufficient for some applications. Applications that require recovery in this layer may use many of the reliable multicast protocols that have been proposed, for example, a conventional RMP or gossip protocol.

In fact, different reliable multicast or gossip protocols can be used in different areas of the network depending on local area characteristics.

The separation between the upper and lower layers of the architecture provides a means of balancing the cost and quality of the network. In the lowest layer, we would like to use the public Internet to reach a large number of customers economically, but, on the other hand, in the upper layer and throughout, we would like to provide delay and bandwidth guarantees that are not currently available on the public network. A compromise is to use a private network for the upper layers of the architecture, that carry the data over the longest distances, and to use the public Internet for the remulticasts to the customers of the lowest layer. The set of receivers R_{T} receives data on the private network and remulticasts it on the public network. The lines in the private network may be leased and managed in the same way as lines in an international corporate network. Bandwidth on the backbone network is not shared with the public network, and the quality of service is guaranteed. As network providers are able to guarantee the quality of service on virtual private networks, or when the public network is able to guarantee the quality of service across many internet service providers ISP, the private lines may be replaced with shared facilities.

The group of receivers R_{T}, take part in TRMP to recover and sequence the messages from sources S. The acknowledged messages in the sequence are timestamped, and the R_{T} remulticast the sequence to the customers R after a delay that is sufficient to guarantee that all of the R_{T} have received the message. The R_{T} are trusted to not favor specific customers R by giving them early access to the data.

Individual customers may join and leave an application frequently, but the set of R_{T} is relatively stable. The customers R do not take part in the TRMP token passing protocol of the present invention and are shown outside dashed line box TRMP. Therefore, it is only necessary to reform a token group when an R_{T} fails or a new R_{T} is installed or disconnected.

There is no limit on the number of customers R that can receive the multicast signal from a given TRMP group receiver R_{T}. However, in order to provide receiver fairness, the region of an R_{T}'s remulticast should be limited by the loss characteristics of the network and the delay from that R_{T} to its R respective customer receivers. In addition, remulticast regions should overlap so that, if an R_{T} fails, an R can obtain the messages from an alternate R_{T}.

Increasing the number of primary receivers R_{P} in the primary token loop PTR, decreases the size of the remulticast regions and improves the quality of the data delivered to the customers R. However, as m increases, the time to detect failed primary receiver R_{P} increases. If m becomes very large, the TRMP protocol becomes susceptible to NAC implosion because of the correlated losses. Our proposal of a layered architecture, with secondary receivers, R_{S} of a secondary token loop STR, improves the quality of the data delivered to the customers R without as large an increase in m.

The secondary receivers R_{S} receive the source messages and acknowledgements on the global multicast tree GMT just like the primary receivers R_{P}, and remulticast the same sequence of messages. However, the secondary receivers R_{S} do not acknowledge source messages and do not take part in the primary token loop PTR. When a secondary receivers R_{S} detects a missing acknowledgement or source message, it requests the message from a specific primary receiver R_{P} that is assigned to support it, rather than from the token site TS. Therefore, the secondary receivers R_{S} do not increase the time required to detect a failed primary receivers R_{P} nor do they add to the NACK implosion on the global multicast tree GMT.

The token site in our primary token loop PTR does not focus on or favor a specific source, as required by a source fairness criterion. Therefore, the multiple loop architecture is better suited for multiple sources than a hierarchical tree, known in the prior art.

The secondary receivers R_{S} in a given region pass a secondary token between themselves to detect failures and guarantee that all of the source messages are received by all of the secondary receivers R_{S}. The secondary tokens are numbered to correspond with the primary tokens, and a secondary receiver R_{S} does not pass the token until it has the acknowledgements and source messages up to that token number. A secondary receiver site R_{S} that receives a secondary token can make the same inferences about the sites in the secondary group as a site that received the primary token could make about sites in the primary group. Each secondary token loop STR includes at least one primary receivers R_{P} on the primary token loop PTR. That primary receiver R_{P} can infer the state of its associated secondary group and transfer that information to the primary group PTR.

As we increase the number of receivers in a secondary group, we encounter the same problems that we encountered as we increased the number m of primary receivers. Two layers of receivers can only reduce the number of token passes required to detect failures or guarantee delivery, L₂, by the square root of the number of passes in a single layer architecture, L₁. If we have a group of 100 receivers, L₁=100. If we organize the 100 receivers into ten secondary groups often receivers, each secondary group requires the square root of 100 or ten token passes to circulate the token. The primary group also has ten members. Therefore, we require ten token passes to detect a failure and L₂=10. If we have 10,000 receivers, L₁=10,000 and its square root L₂=100.

We can generalize the layered receiver architecture. With i layers, L₁=

i\sqrt{Lᵢ}

The land surface of the earth is about 57×10⁶ square miles. If we place 10,000 receivers uniformly over the surface, the maximum distance to a receiver is less than fifty miles, which is most likely adequate to provide our delay and loss guarantees. Since our stock market systems will not have to provide uniform access to the entire land surface of the earth, there is mostly ocean on our planet, two layers of receivers should be more than sufficient to limit our primary and secondary token loops to a few tens of receivers each.

Within a region, as introduced above, we can provide two grades of service: best effort and guaranteed delivery. Best effort only delivers the messages that are not lost in the regional area to the customers R. Guaranteed delivery recovers all of the messages. We may guarantee delivery by colocating retransmit or repair servers, Rₓ, with the R_{P} or R_{S} as shown in FIG. 2. When a customer R detects a missing sequence number, it can request the message from repair server Rₓ.

The primary sources S_{P} are trusted to enter valid data messages into the reliable multicast group. There are authentication and certificate granting systems that can extend trust to a large number of sources S_{P}. However, we can keep tighter security with a smaller number of participants. In addition, TRMP requires that each participating receiver R_{T} maintain state information for each source, such as the next expected message number, and some of the cryptographic techniques that we will use require receivers to share a secret with each source. It is difficult to maintain source specific information when the number of sources is large.

While the constraint on the number of sources is not as severe as the constraint on the number of receivers, there should not be millions or ten's of millions of sources in a TRMP group. In order to keep the number of sources that participate in TRMP to a few thousand, the sources can also be layered. The primary sources Sp participate in TRMP, and the primary sources S_{P} trust a set of secondary brokers, S_{S}, and in turn each secondary source S_{S} may trust a set of customers S, not shown but similar to the receiver section of FIG. 2.

The set of TRMP participating sources S_{T}={S_{P},S_{S}} are trusted by the network. The degree of trust depends upon the security mechanisms that are used in the network, as discussed subsequently. The set of TRMP sources S_{T} can be owned by the network and operates as a firewall between the public Internet and the private backbone network. They can be privately owned sources that transmit data on the private backbone, such as the stock exchanges described above or subsequently, or they can be privately owned firewalls, such as licensed stock brokers. The set of TRMP sources S_{T} that operate as firewalls are responsible for verifying the authenticity of the customers or the data. The set of sources S_{T} may each use different password or authentication systems. If the set of sources S_{T} are owned by the network, the network owner should determine if the different systems compromise the security of the network. If the set of sources S_{T} are licensed brokers, they may be required to act as insurers and accept responsibility for any data that they enter into the network.

Striping Used In Distributing Data

The amount of data in the composite stock ticker will almost always exceed the bit rate that can be transmitted to an individual customer, R. The amount of data in the composite ticker may also exceed the amount of data that can be processed by an R_{T} in the repair group R_{X}. Both of these problems are addressed by “striping” stocks into common groups. However, the stripes that are used to solve the two problems will likely have different widths.

In the core of the network, stocks may be organized in stripes of related stocks. A stripe is limited to a group of stocks that have few enough messages to be processed by all of the R_{T}. Each stripe uses a different multicast address and the entire network of RT's is replicated for each stripe. Since the set of TRMP receivers R_{T} is provided by the network, rather than the customers, we can assume that all of the processors are similar—no weak links—and that they are among the more powerful processors that are available. There should be a relatively small number of wide stripes in the core of the network.

A TRMP receiver R_{T} organizes the data that it receives on a core stripe into narrower stripes of more closely related stocks and transmits each edge stripe on a different remulticast address. The amount of data on an edge stripe is limited by the least capable of the customers R and the more capable customers R receive multiple stripes. For instance, if the least capable customers R have 56 Kbps modems, TRMP receiver R_{T} organizes the data into 56 Kbps wide stripes. A customer R with a 56 Kbps modem may select any one remulticast address and receive information on a small group of stocks, while a broker R with a much larger bit rate capacity, for example, with a 45 Mbps connection, may simultaneously view the information on the stocks in 800 different stripes. There should be a relatively large number of narrow stripes at the edge of the network.

Referring now to FIG. 3, the fairness requirements, time constraints, the quantity of data transferred, the distance spanned, the number of users served, and the availability requirements of the stock market applications require modifications of RMP as introduced above and now further described. The timed reliable multicast protocol, TRMP, of the present invention is a modified RMP. The major changes are: 1) multiple (nested) loops, 2) delayed simultaneous delivery, 3) time driven, rather than event driven, token passing, 4) NACK reduction, and 5) a reformation protocol for reforming loops. Each will be described in turn.

Multiple loops result in multiple tokens. In order to guarantee that each source message is only acknowledged once, and that there is a unique sequence of messages, only one of the tokens transfers the right to acknowledge messages. Remaining tokens are circulated to test the receivers and to determine when we can guarantee that all of the receivers have specific messages.

In TRMP, the set of TRMP receivers R_{T} wait a delay Δ_{A} between the time a message is acknowledged and the time that it is remulticast. The R_{T} have synchronized clocks. The clocks can be synchronized by a known synchronized network protocol, or by receiving a timing signal from a satellite, such as the global positioning system (GPS), and adjusting for differences in the propagation delay among other known techniques for synchronizing a global network. When the token site T_{S} acknowledges a source message, it timestamps the acknowledgment. The set of TRMP receivers R_{T} remulticasts a message Δ_{A} after the message's time stamp. The delay Δ_{A} compensates for the difference in reception times at the different TRMP receivers R_{T}, caused by differences in delay from the source and the time to recover missing messages. A system is fair when all of the TRMP receivers R_{T} simultaneously retransmit received messages to their local customers R.

The propagation delay around the circumference of the earth is about 150 milliseconds and the network delays between receivers are at least a few hundred milliseconds. Therefore, we do not transfer the token more than 2 or 3 times a second. If we only acknowledge a single source message each time that the token is passed, the message arrival rate in some of the stock market applications will exceed the limits of the protocol. In our TRMP, the token is transferred periodically, every tₜ seconds, and acknowledges all of the unacknowledged source messages, including any messages that were missed by the previous token sites. TRMP does not have an upper bound on the message rate. The t^{th} token passing message acknowledges a sequence of k source messages, where k is variable. The k messages are assigned sequence numbers s to s+k−1.

We can acknowledge multiple source messages in an event driven protocol rather than passing the token periodically. However, periodic token transfers reduce the number of token transfers until we can guarantee that all of the operable receivers have the message from m, the number of receivers in the logical token loop, to “1”.

Another advantage of periodic token transfers is that the set of TRMP receivers R_{T} detects a failed token when a token is not transferred on time. In an event driven RMP, sources detect a failed token site when a message is not acknowledged. Removing failure detection and reporting responsibility from the sources makes it possible to operate with less trusted sources. This can be an important characteristic in an environment where all trading floors are not equally trusted.

NACK implosion is considered a serious problem in conventional reliable multicast. Our layered architecture reduces NACK implosion. TRMP uses token passing to reduce NACK implosion. Conventional NACK reduction mechanisms increase the delivery delay and need not be used in the stock market applications.

In the original reformation protocol, communications in the entire system stopped during reformation. The stock market applications require a high availability, and it is necessary to keep the communications disruptions to a minimum. In the reformation protocol according to the present TRMP, communications may only stop on a portion of the system. In addition, the reformations take much less time, so that communications disruptions are shorter.

In conventional RMP, a receiver does not know that it has missed an acknowledgement until it receives a higher numbered acknowledgement. RMP is event driven, and higher numbered acknowledgements aren't transmitted until the token site receives the next source message. The probability that a receiver is unaware of a missed acknowledgement is a function of the number of additional acknowledgements that have been transmitted, and decreases with time. There is a tradeoff between Δ_{A} and the fraction of the operable R_{T} that remulticast the message simultaneously. However, we cannot guarantee that all of the operable R_{T} can remulticast the message for any Δ_{A}.

In TRMP, we can make the claim that all of the operable TRMP receivers R_{T} remulticast a message simultaneously when Δ_{A}≧τₜ. The claim holds when τₜ, the token passing time, satisfies the inequality τₜ≧(2nₘₐₓ+½) T_{R}. In this relationship, T_{R} is the time between retransmission requests and nₘₐₓ is the maximum number of recovery attempts before declaring a failure. When a single source and destination use a positive acknowledgement protocol, we cannot guarantee that the message is delivered to an operable receiver in less than nₘₐₓT_{R}. Therefore, the guaranteed delivery time in our multicast network is only 2.17 times that on a point-to-point link, when nₘₐₓ=3.

In dedicated networks, we make the time between retransmission requests T_{R} greater than the round trip delay through the network. However, in packet networks, the delay is a random variable and can be virtually unbounded. The penalty for making T_{R} smaller than some of the round trip delays is that we may occasionally declare an operable receiver R_{T} inoperable and perform an unnecessary reformation. The penalty for increasing T_{R} is that we increase Δ_{A}, the delay until we obtain multicast stock information. Since reformations are not an expensive operation in our system, we should not try to make T_{R} long enough to eliminate all unnecessary reformations.

Referring to FIG. 3, there is shown an extended finite state machine for our TRMP protocol. The transitions are labeled with the conditions that initiate the transition. The “*”'ed labels are the state variables that are modified when a transition occurs. All of the receivers R_{T} are in state 1 310 at time tₑ when the acknowledgement Ack(e) is scheduled to be transmitted. A receiver R_{T} that does not receive Ack(e) before time tₑ+T_{R}/2 moves to state 2 320. (T_{R}/2 is the nominal bound on the one-way network delay.) A receiver R_{T} that has received the acknowledgement moves to state 4 340.

A receiver in state 2 320 that has made nₘₐₓ or fewer requests, requests Ack(e) and waits in state 3 330. If Ack(e) is received within T_{R} seconds, the receiver moves to sate 4 340; otherwise, it returns to state 2 320. If the number of requests equals nₘₐₓ, the receiver declares that the token site has failed and moves to reformation state 7 370. Inmost standards for positive acknowledgement protocols nₘₐₓ=3.

By time tₑ+(nₘₐₓ+½) T_{R}, a receiver has either passed through state 4 340, or has entered a reformation state 7 370. If the messages that are acknowledged by Ack(e) have been received, the receiver moves from state 4 340 to state 8 380, otherwise it moves to state 5 350. The operation of states 5 and 6 are the same as states 2 and 3. Within time nₘₐₓT_{R} after entering state 4 340, a receiver is in finish state 8 or reformation state 7.

Therefore, by time tₑ+(2nₘₐₓ+½) T_{R}, all of the receivers are in finish state 8, or one or more of the receivers R_{T} have declared that the token site T_{S} has failed. When Δ_{A}≧(2nₘₐₓ+½)T_{R}, either every operable R_{T} has the acknowledged messages and remulticasts them simultaneously, or the system is being reformed, state 370. If the token passing interval τ_{t≧(}2nₘₐₓ+½)T_{R}, we can guarantee that, if the system is not being reformed, no receivers R_{T} have to recover Ack(e) or Msg(e) at t≧tₑ₊₁ (where tₑ₊₁=tₑ+τₜ). Since the next token site T_{S} has recovered all of the preceding messages and acknowledgements by time tₑ₊₁, it sends Ack(e+1) on time.

There are a number of things that we can do to make Δ_{A} smaller: 1) instead of counting nₘₐₓ independently in states 2 and 5, we can test the sum of the retries in both states. For instance, if we allow a maximum of five retries in both states 2 and 5, rather than a maximum of three retries in state two and three retries in state 5, Δ_{A} is reduced by T_{R}. The probability of entering reformation state 7 when the token site has not failed may also be reduced by limiting the sum of the retries. 2) We can schedule tₑ₊₁<tₑ+(nₘₐₓ+½)T_{R}. Most of the time the next token site will be ready to transmit on time, but occasionally it will be late. When the token site transmits the acknowledgement later than scheduled, the retransmit timers at the receiver start before the acknowledgement is available and the probability of entering reformation state 7 when the token site has not failed, increases. 3) We can recover both Ack(e) and Msg(e) in states 2 and 3, even if only one is missing. This increases the amount of data retransmitted, but cuts out half of the retrys. Our objective is to recover all of the messages as quickly at all of the multicast receivers as we can between a single source to destination.

Negative Acknowledgement (NACK) Reduction

The conventional mechanism for reducing negative acknowledgement NACK implosion in reliable multicast systems using conventional RMP is to limit the subset of receivers that request a missing message, but to multicast the missing message to all of the receivers. In subsequent intervals of time, different subsets of receivers can request the missing message until all of the receivers have had an opportunity. If a receiver requests a message and a receiver that is scheduled to request the message in a later interval receives the multicast, the later receiver does not request the retransmission, and the n umber of NACK's is reduced. This strategy is particularly useful in the Internet where the multicast is transmitted on a tree and many receivers miss the same message and so may be used in the lowest layers of FIG. 2.

In our TRMP, the receiver R_{T} in the upper layers of FIG. 2 that accepts the token must have received all of the previous messages. Therefore, when we define subsets of receivers that request missing messages, we must guarantee that a receiver has an opportunity to recover a missing message before it becomes the token site TS.

The simplest and most economical method of defining the subsets in TRMP is to have one receiver in each subset, the next token site. A receiver only requests missing messages before it becomes the token site TS. The disadvantage with this approach is that a site may have to wait an entire token rotation before it can recover a missing message. The number of token passes before we can guarantee that all of the operable TRMP receivers R_{T} have a message increases from 1 to m.

We can reduce the time until a site recovers a missing message by giving several sites the opportunity to request the missing message. The maximum time until a receiver can request a missing message is minimized when we space those sites equidistant around either a primary or secondary token loop. Specifically, if token t is sent by receiver r, define sets of receivers s_{i,t}={(r+i+1+j*kp)mod m for 0≦j≦(m−i−1)/kₚ}, for i=0,1, . . . ,kₚ−1, where there are m receivers numbered 0 to m−1 in the token group. A receiver in S_{i,t} can request the acknowledgement sent during interval t, or the source messages that it acknowledged, during interval t+i, if they are still missing. With this assignment, we can guarantee that every receiver has a message within kₚ token passes.

If m/kₚ is a integer, each receiver requests any missing messages in the interval when it is scheduled to accept the token, and every kₚ^{th} interval after that. In the other (kₚ−1)^{th} intervals, the receiver listens in case one of its missing messages is requested by another receiver.

Since receivers in the later sets do not request a missing message when receivers in earlier sets request that message and the retransmission is received, the average number of requests for retransmission is clearly reduced. If, on the average, there are more sites that miss the message than there are sets, we can further reduce the average number of requests by putting fewer receivers in the sets that make the initial requests than in the sets that make later requests. We can “tune” the number of receivers in each set so that, on the average, the probability of a request is the same in each subset. We can also reduce the number of requests by placing receivers in different sets if they are likely, because of their positions on the original multicast tree, to miss the same messages.

A problem with limiting the number of receivers that transmit a NACK is that it increases the average delay until a missing message is acquired. For this reason we do not recommend this NACK reduction mechanism in the stock market applications except in the local receiver lowest layers of the architecture. In a different application, we may replace fairness with a penalty for delay, and this NACK reduction mechanism may be useful.

Reformation in TRMP

The reformation process is initiated by the positive acknowledgement protocols that are part of either RMP or TRMP. In positive acknowledgement protocols, the source assumes that the receiver has failed if it does not receive an acknowledgement after a specified number of retransmission attempts. In conventional RMP, token site failures are detected when a primary source S_{P} fails to receive an acknowledgement for a message or a TRMP receiver R_{T} cannot recover a missing message or acknowledgement. A failure in the next token site is detected when the current token site cannot pass the token. Since there are no control messages transmitted by the R_{T} when there are no messages from the primary source Sₚ, we must depend on the primary source Sₚ to detect token site failures in a quiet system.

TRMP as described above transfers the token periodically. In TRMP, we do not depend on the primary source Sₚ to detect failures. Instead, all of the R_{T} detect a token site failure if the token is not passed on time. In conventional RMP, the Sₚ could act maliciously and disable the system by continuously putting it into a reformation state, or could neglect to restart a system that has lost the token. In TRMP, the primary source Sₚ can be less trusted as will be further discussed below.

Referring to FIG. 2, the TRMP reformation protocol in the stock market applications is preferably centralized. When a receiver R_{T} detects a failure, it notifies a reformation server, X_{R}. There are preferably redundant X_{R} in case one fails. The reformation server X_{R} is responsible for forming a new token loop on the particular primary or secondary loop, PTR or STR, that has changed. There is no election protocol.

To form a new token loop, the reformation server X_{R} performs a straightforward loop bypass or insertion. All of the receivers in a logical loop are numbered. If reformation server X_{R} receives a report that receiver r has failed, X_{R} instructs receiver (r−1) mod m to transfer the token to (r+1) mod m, and gives the token to receiver (r+1) mod m. If either or both of these receivers have failed, reformation server X_{R} selects the next or prior receiver that has not failed, and instructs those receivers to bypass failed receiver r. When failed receiver r recovers, it contacts reformation server X_{R} and asks to be reinstalled in the token list. Reformation server X_{R} notifies receiver (r−1) mod m, or the previous operating receiver, to pass the token to r, and instructs r to pass the token to (r+1) mod m, or the next operating receiver.

The numbering scheme on a sub-loop is internal to the reformation server X_{R}. The receivers pass the tokens using the network address for the other receivers. The receivers that reformation server X_{R} calls r and (r+1) mod m are at the network addresses A₁ and A₂. During normal operation, the receiver at A₁ transfers the token to the receiver at A₂. By using network addresses, the strategy for bypassing or re-inserting receivers can also be used to change the system when new receivers are added or when an existing receiver is retired. If a new receiver, at address A₃ is added to the token loop following r, reformation server X_{R} must increase m and all of the receiver numbers greater than r by one, but must only notify receivers A₁, A₂, and A₃ about the addition to the token loop.

The primary reason for using this reformation procedure is that it is less disruptive of the information flow than the original protocol. The centralized protocol restores a lost token more quickly than the distributed protocol. The centralized protocol doesn't have an election phase to determine a reformation server X_{R}. Furthermore, since the centralized procedure fixes one fault at a time, it only communicates with two receivers rather than using a three phase commit procedure to determine and order all of the operable receivers. In fairness, the original reformation protocol was more concerned with guaranteeing the state of a distributed database than with resuming communications as quickly as possible.

A second reason why the present reformation process is less disruptive is because the network is organized into a hierarchy of, for example, primary and secondary loops, rather than a flat structure. When a failure occurs on a secondary loop STR, the primary loop PTR continues to operate, and most of the system continues to acknowledge and order source messages during a reformation. The affected loop catches up as soon as the failed token site is bypassed. The only time that we stop acknowledging source messages is when the token is lost on the primary loop PTR. There are fewer components on any of the sub-loops with the hierarchical structure than the flat structure. Therefore, any sub-loop, and in particular the primary loop PTR, enters a reformation process less often.

Another reason for using a centralized TRMP reformation protocol is that the reformation server X_{R} in this system must have access to more information than in the conventional RBP or RMP applications. The reformation server X_{R} must know the structure of the sub-loops in order to perform a simple bypass. If a bypassed receiver r is at a junction between two sub-loops, reformation server X_{R} preferably assigns the responsibility for joining the sub-loops to a surviving receiver. In addition, the reformation operation preferably adjusts the multicast regions (time-to-live fields) and may change the remulticast addresses, so that every customer R receivers at least two multicasts on different addresses. The information about, and state of, the system is easier to maintain in a small number of reformation servers X_{R} than in all of the TRMP receivers R_{T}.

We are assuming that the design of the architecture of FIG. 2 is performed manually. However, as the system 200 grows, this process may be automated once, from enough experience, it may be determined what parameters should be optimized and how.

Security in TRMP and a Distributed Architecture

The present TRMP addresses the following security concerns: 1) constraining transmission access to authorized sources, 2) preventing early reception of the data stream, 3) limiting reception to authorized receivers, 4) spoofing or adding to the repaired sequence, and 5) denial of service.

The first two concerns address the core of the system TRMP where TRMP operates. The global multicast group in the core is G_{M}{S_{T},R_{T}}. The final three concerns address the remulticast data at the edge of the system TRMP.

In this section we expand on these five concerns and map them onto known networking or cryptographic problems. There exist solutions for each of these problems. For example, we can make good use of conventional time-lock puzzles and solutions that release information after a delay. One advantage in reducing our security issues to known problems is that we may be able to use any refinements in the known solutions to these problems, and we may also make use of future standards.

The first security concern is that a source outside our set of S_{T} will transmit messages that are placed in sequence of messages that are remulticast. In a stock market application, one trader may find advantage in providing other traders with mis-information. We can address this concern with cryptographic techniques, networking techniques, or both.

In our architecture, there are only a few hundred S_{T}. If each S_{T} shares a secret key with the group of R_{T} and encrypts its messages, we can operate G_{M} on the public Internet. When each S_{T} has a different key, the encryption also identifies the source. This reduces the amount of trust that we must place in the S_{T}, since an S_{T} that is inserting mis-information cannot masquerade as another source.

Alternatively, we can operate G_{M} on a private network, or a virtual private network. The set of R_{T} receives data on the private network and remulticasts it to the customers on the public network.

In applications where there are many more sources than the S_{T}, the S_{T} may act as firewall between the public network and the private network, and verify the right of the customers R to place a message on the private network. Network providers currently prevent external access to international, corporate private networks and are proposing techniques to protect virtual private networks.

The second security concern is that an unauthorized receiver will eavesdrop on G_{M}. The group of TRMP receivers R_{T} delays the multicast messages before they are remulticast to customers R so that all of the receivers get the messages simultaneously. Clearly, in the stock market applications, investors can take advantage of obtaining information on trades before other investors. This concern can also be addressed by networking or cryptographic techniques.

If the S_{T} encrypt their transmissions with a key that can only be decrypted by the R_{T}, the information is protected from the R and can be transmitted on the public network. The R_{T} are owned by the network and are trusted not to divulge the message early. If the S_{T} each use a separate secret, they do not have to be trusted not to divulge the information from the other S_{T} before the delay imposed on the R_{T}. Reducing the degree of trust of the S_{T} may be significant in a distributed stock ticker if the trading floors are given direct access to the core network.

The original multicasts are only available on the core TRMP of the network. Therefore, the private networking techniques that constrain transmission on the core network also prevent receivers that do not have access to the core from gaining early access to the information. If the network provider is trusted to prevent eavesdropping, the degree of security that is obtained with a firewall can be equal to other cryptographic techniques.

The third security concern is to restrict access to the data that is remulticast by the R_{T}. There are electronic stock markets, like NASDAQ, that require the customers R to be part of a private network in order to protect access to the data. However, our objective is to make our system accessible to the general population, less expensively, by using the public Internet to connect the customers R. A stock market application can sell the remulticast sequence over the public Internet by the month, like a subscription for a newspaper. To sell the sequence, the R_{T} decrypt the messages from the S_{T}, then re-encrypt the entire sequence with a new key. The key is sold to each of the customers R, and is changed when the subscriptions expire.

The decryption key is sold to a large number of customers, and we must discourage someone who buys the key from giving it to others. In a previously described electronic publishing system, the decryption key according to one inventor of the present invention is included in a program that is sent to each subscriber. A subscriber pays for the service with his credit card, and the key in the program is masked by the credit card number. In order to give away access to the data, a customer must give away his credit card number. While this does not prevent a person from giving away the program, it should discourage most people.

The final two security concerns are similar to the first concern, but occur on the remulticast groups on the public Internet. A malicious user may insert false messages into the sequence or may flood the multicast group to prevent others from receiving the repaired sequence.

The conventional cryptographic approach for dealing with pretenders is digital signatures. Since there are a large number of untrusted receivers, the digital signature preferably uses known public key cryptography. In a public key system, only the remulticast source can sign the message, but any receiver can verify that the message is legally signed. Unfortunately, public key systems may require more computation than should be performed in this application.

Alternatively, we can use unique message numbering in our system as a partial alternative to signatures. In most instances, it is much easier to insert messages than it is to delete messages. The numbering provides a means of detecting added messages. We cannot tell which of the duplicate numbers are real, but we can decide that some messages are forgeries and not act on any of the information.

We cannot use cryptographic techniques to prevent an attacker from flooding the remulticast group with a large number of phony messages. Although we may detect the attack, the attacker can deny service to the customers R. Since there is only one source, R_{T}, in each remulticast group, we can eliminate illegal transmitters by configuring routers to only multicast the signal from a particular source on a particular port.

Three Applications of TRMP in a Distributed Architecture

Three stock market applications, as discussed briefly above, that we have considered include: 1) a unified ticker of the transactions from a number of physical and electronic trading floors; 2) a merged stream of buy and sell orders; and 3) a distributed trading floor.

The first application has a relatively small number of sources and a very large number of receivers. The second application has a very large number of sources and a relatively small number of receivers. The third application has the same number of sources and receivers, both of which may be large.

In the first two applications, we are primarily interested in fairness, information delivery or market access fairness. TRMP is used to create a level playing field for investors independent of their location. In the third application, we are also interested in providing the same sequence of messages to every receiver, so that receivers can independently determine which transactions have occurred. In addition, the third application requires guarantees that a specified number of operable receivers have witnessed a transaction, so that the transactions can survive system failures.

In the unified ticker, every investor receives a list of the trades on every trading floor. The objective is to create a level playing field where all of the investors have the same information on trades. The investors receive the list in the same order, at the same time, no matter where in the world they are located.

The sources, S_{T}, are the trading floors. The trading floors operate independently under their own rules and customs. Some may be physical places, others may be Internet servers, and still others may be the distributed trading floors described in the third application.

The core network is a private network. The bandwidth on this network is guaranteed, and firewalls protect the network from mischief. The trading floors are inside the firewall and multicast their list of trades directly on the TRMP group. Each trading floor shares a different secret key with the TRMP group of receivers, R_{T}, and encrypts the messages that it places in the multicast sequence.

The encryption serves two functions: First, it acts as a signature of the trading floor that has entered the data, and second, it prevents a trading floor from acquiring and using the information from the other floors before it is available on the unified ticker. The second function is important because the trading floors may not be equally trusted. Many of the new electronic exchanges have not had time to establish trust, and the different floors in an international system have different regulatory agencies, with different rules and penalties. The trading floors are only trusted to transmit an honest and timely accounting of their trades and not to divulge their own trades before they are reported on the unified ticker. We assume that this degree of cooperation can be enforced by the regulatory agencies or by the fear of being excluded from the unified ticker.

The multicast TRMP receivers, R_{T}, are owned by the network operator and are trusted to protect the unified ticker until it is scheduled to be distributed. At delay Δ_{A} after the timestamp, all of the receivers R_{T} decrypt a source message and remulticast that message in their regional areas. The remulticasts are outside the firewalls of the private network. If the unified ticker is being sold, the receivers R_{T}, re-encrypt the ticker with a distribution key, as described above.

The remulticast messages may be lost. A customer R detects lost messages by gaps in the sequence numbers. Missing messages can be acquired from repair server Rₓ. The data transmitted in a unified ticker is temporal and many customers may only be interested in the most recent stock prices. Once the next value of a stock is received, there is no reason for these customers to retrieve the previous price. There may be other customers who wish to accurately plot the stock price to predict trends. These customers may retrieve the missing transactions from repair server Rₓ.

There is an expense associated with maintaining repair servers Rₓ. The network provider can recover the expense by selling two levels of service, one with and one without retransmissions. It is likely that the same messages will be lost by many receivers in a region. Therefore, retransmissions should also be multicast, rather than sent by point-to-point communications to select receivers. The retransmissions can be restricted to a sub-group of the original customers R by encrypting them with a different key than the original multicast. The retransmit key can be sold separately, but by the same technique as the multicast key, so that only receivers that pay for the higher level of service can decrypt the retransmitted messages.

The amount of data in a unified stock ticker will be significantly greater than the amount of data that a typical user can receive. This problem is addressed by organizing the data into “stripes” of related stocks as discussed above. Different customers R may have very different data rate connections to the network, and the size of the stripes is determined by the least capable receivers that are supported. If the least capable receiver is 56 Kbps, the stocks in a stripe are restricted so that their composite data rate is unlikely to exceed 56 Kbps. Each stripe is transmitted on a different multicast address. A trader with a 56 Kbps modem, for example, can only select one stripe at a time while a trader with a 1.5 Mbps line may simultaneously follow the stocks on 25 stripes.

Striping may also be necessary in the backbone network if the data rate of the composite ticker exceeds the throughput of the TRMP receivers R_{T}. The R_{T} are owned by the network. It is unlikely that some R_{T} will act as severe bottlenecks and reduce the size of the stripes much below the size required by the other R_{T}. The stripes in the backbone network will be much wider than those at the edge of the network. The entire multicast infrastructure, Rp's, Rₛ's. and Rₓ's, is duplicated for each stripe. The primary sources Sₚ transmit transactions involving different stocks on the appropriate stripe.

The second application is a unified order application. The unified order system is a sequence of offers to buy or sell stocks at a given price. The offers can be directed to a specific exchange or can be open to all participating exchanges. Our objective is to give all of the traders a fair opportunity to place their bids in the sequence of offers.

If the buy and sell offers are directed to a single exchange, the order of the sequence may be binding on the trades that occur. If the offer is open to all exchanges, the offer may just be an invitation for a broker to close a deal.

This system may be considered as the inverse of the unified ticker. There are many sources and a small number of receivers. In the degenerate case, there is one receiver, a single trading floor. It may seem wasteful to circulate the token among the primary receivers Rₚ that are distributed around the world, just to give the sequence to a single trading floor in a single location. However, the circulating token provides fairness.

If all of the sources transmit their offers directly to the trading floor, the sources that are in the same city as the exchange have an advantage over sources on the other side of the world. First, the propagation and network delays may be seconds shorter for the closer source, and second, the average number of transmission retrys may be significantly smaller for the closer sources.

In a conventional communication system, if two traders in different parts of the world simultaneously try to enter a bid, the trader in the same city as the trading floor will almost always have its bid registered first. With a rotating token, the portal that allows messages to enter the system spends equal amounts of time at different locations on the globe. The trader that gets into the system fastest depends on where the portal is located when the traders decide to enter their offers, and not where the trading floor is located.

The sources in this application include brokers and individual traders as well as other trading floors. These sources cannot be trusted to the same extent as the trading floors in the unified ticker.

The sources may make offers without the proper resources, or may transmit a large number of messages to disrupt the system. In addition, there may be too many of these sources for the R_{T} to have a different shared secret with each.

Both of these problems are solved by not giving the sources direct access to the multicast group. The sources, S_{P}, are either owned by the network or are completely trusted. These are the only sources inside the network firewall. The sources, S, must present credentials to the S_{P} that they own the stock that they would like to sell or that they have the funds that they would like to spend. Alternatively, the S may have accounts with the Sₚ, in which case they must prove their identity by an agreed upon password system. If there are too many S for the network based Sₚ to track, there can be secondary sources, S_{S}, in a secondary source token loop that trust the S and are trusted by the S_{P}.

The third application, a distributed trading floor, uses TRMP to construct a distributed, international trading floor. The participants may be individual traders, brokers, or the other trading floors. This trading floor may also be one of the sources that reports trades in the unified ticker. All of the participants enter buy, sell or stop orders and see the same sequence of orders from all of the participants. Depending on the sequence, each participant knows which trades have occurred.

This application has many of the problems of the previous two applications. There are large numbers of sources and receivers, none of which is trusted. Both the S_{T} and R_{T} are network based and are distributed around the world to provide fair entry and distribution of the data. The S_{T} verify the credentials of the sources S and enter the bids. Based upon the TRMP sequence and the rules of the particular trading floor, an arbiter declares which trades have been made and reports the trade on an appropriate ticker. By making the token site the arbiter, we guarantee that the arbiter has the most complete acknowledged sequence of buy and sell orders.

There are a number of different rules that the arbiter can use to make trades. Some of the differences between the rules are semantic. If one participant offers to buy a stock at price A and another offer to sell the stock at price B<A, an issue is whether the trade should be made at A, B, or somewhere in between. Other differences in the rules are a matter of style. Some floors may post buys and sells, others may be run a single round, high bid auction, where the highest bidder gets to buy the stock at the price offered by the second highest bidder. Other floors may be modeled after the Amsterdam flower auction.

TRMP according to the present invention offers very strong guarantees that can be used to make trades reliably even when there are system failures. For instance, assume that the token site is the arbiter. A primary receiver R_{P} that has the token can report a tentative trade that is based upon the bids that have been acknowledged, and the bids that are about to be acknowledged. The next token site guarantees that two operable primary receivers R_{P} have recorded the trade. By waiting N token passes after a trade is reported, before committing the trade, we can guarantee that information on the trade will not be lost when there are up to N failures.

Note that guaranteeing that N operable receivers have a message is different from guaranteeing that all of the operable receivers have a message. We may suspect that there are more than N operable receivers, but at any instant in time we cannot guarantee that there are more than N operable receivers. By passing the token we can guarantee N−1 token passes later that there were N operable receivers.

While we have described a proposed globally distributed architecture and protocols for an Internet-based global stock exchange including a private core TRMP network, the proposed hierarchy of transmitters and receivers that address the security concerns of the stock market may be modified by one of ordinary skill in the art and adapted, for example, to utilize different protocols in different local regions. Nevertheless, the present TRMP used at high levels of the hierarchy guarantees that all of the operable receivers have an acknowledged message within a single token passing time.

The token passing time is only 2.17 times the time required to guarantee delivery in a positive acknowledgement protocol that operates between a single source and destination. All references to published works cited herein should be deemed to be incorporated by reference as to essential subject matter. The present invention should only be deemed to be limited in scope by the claims that follow.

What we claim is:

1. A distributed data distribution network for equity markets comprising a plurality of backbone nodes utilizing a timed reliable multicast protocol for data transmission, the backbone nodes being geographically distributed about the world and a cluster of trading nodes of a region connected to each backbone node such that an acknowledgement is time-stamped with a time when it is first sent and, after a predetermined time period T, a receiving node retransmits an acknowledgement message within its region.

2. A distributed data distribution network as recited in claim 1 further comprising encryption means at a message source for encrypting messages with a key for decryption only by a receiver that capable of timed reliable multicast protocol operation.

3. A distributed data distribution network as recited in claim 1 further comprising a repair server and an individual receiver having one of two grades of service, the first grade of service permitting a receiver having a first grade of service to recognize a missing message from a sequence number and to request a missing message from said repair server.

4. A distributed market data distribution network as recited in claim 1 further comprising a clock for synchronizing backbone node receivers and a token passing message is transmitted periodically.

5. A distributed market data distribution network as recited in claim 1 wherein said plurality of backbone nodes further comprise a timed reliable multicast protocol token loop and said regional trading nodes comprise a regional token loop utilizing another multicast protocol.

6. A distributed multicast architecture for equity markets comprising a primary source and a plurality of primary receivers, said primary source and receivers being intercontinentally distributed and using a timed reliable multicast protocol characterized by a periodic token passing message, at least one primary receiver being logically connected to a plurality of secondary receivers of a geographic region.

7. A distributed multicast architecture as recited in claim 6 wherein said secondary receivers form a secondary token loop comprising at least one primary receiver, said primary receivers and said primary source utilizing said timed reliable multicast protocol and said architecture further comprising a local multicast tree comprising at least one secondary receiver of a secondary token loop for delivering multicast messages to a plurality of logically connected receivers in said geographic region.

8. A distributed multicast architecture as recited in claim 6 wherein at least one of said plurality of logically connected receivers in a geographic region are logically connected to one of another secondary receiver or a primary receiver.

9. A distributed multicast architecture as recited in claim 6 further comprising at least one secondary source token loop comprising said at least one primary receiver logically connected to said primary source, said primary source and said at least one primary receiver forming a primary token loop.

10. A distributed multicast architecture as recited in claim 6 where a primary source and said primary receivers comprise a network of servers having Internet protocol multicast functionality.

11. A distributed multicast architecture as recited in claim 6 where a primary source and said primary receivers comprise a network of servers having application layer multicast functionality.

12. A distributed multicast architecture as recited in claim 9 further comprising a local multicast tree logically connected to at least one secondary receiver of a secondary receiver token loop comprising said plurality of secondary receivers of a geographic region, said tree for delivering multicast messages to said at least one logically connected receiver in said geographic region.

13. A distributed multicast architecture as recited in claim 6 further comprising at least one reformation server, responsive to detection of a failure by one of a primary receiver or a primary source, for reforming a primary token loop including said primary source or receiver detecting said failure.

14. A distributed multicast architecture as recited in claim 13 said at least one reformation server being further responsive to detection of a failure by one of a secondary source or receiver for reforming a secondary token loop including said secondary source or secondary receiver detecting the failure.

15. A distributed multicast architecture as recited in claim 6 wherein said primary source verifies the right of a customer to multicast a message via said timed reliable multicast protocol.

16. A distributed multicast architecture as recited in claim 6 wherein said primary source encrypts a message for transmission via said timed reliable multicast protocol via a key that can only be decrypted by said primary and secondary receivers.

17. A distributed multicast architecture as recited in claim 6 wherein each transmitted message is assigned a unique sequence number and each primary and secondary receiver has a unique identifier.

18. A distributed multicast architecture as recited in claim 6 wherein a set comprising said primary source, said primary receivers and said secondary receivers comprise a private secure network.

19. A distributed multicast architecture as recited in claim 6 wherein a primary and a secondary receiver each remulticast a given multicast message to a secondary receiver after a uniform delay sufficient to permit said primary and secondary receivers receiving a message from said primary source time to receive said given multicast message.

20. A distributed multicast architecture as recited in claim 13 wherein said failure detection comprises a failure of a primary server to pass a token within a predetermined time period.

21. A distributed multicast architecture as recited in claim 7 wherein said local multicast tree utilizes a reliable multicast transport protocol for distributing messages to said logically connected receivers.

22. A distributed multicast architecture as recited in claim 7 wherein said local multicast tree utilizes a multicast protocol different from said timed reliable multicast protocol.

23. A reliable multicast protocol comprising the step of periodically transmitting a token passing message after a periodic delay sufficient for receivers to receive a data message.

24. A reliable multicast protocol as recited in claim 23 comprising the further step of detecting the failure of a node when a token is not transferred within said periodic delay to another node.

25. A method of distributing a multicast stock ticker, the method for use in a network comprising a primary token loop including a primary source and primary receivers distributed intercontinentally utilizing a timed reliable multicast protocol, the method including the steps of periodically transmitting a token passing message within the primary token loop and a primary receiver remulticasting the multicast stock ticker to at least one user receiver within a given region at the same time as another primary receiver of another region.

26. A method of distributing a multicast stock ticker as recited in claim 25 wherein, said user receivers having variable data rate capacity, said method further comprising the step of striping stocks into a striping group of related stocks and replicating said primary receivers as a network for receiving a stock ticker for said striping group.

27. A method of distributing a multicast stock ticker as recited in claim 26 wherein a receiver having a high data rate capacity receives a stock ticker comprising a plurality of striping groups of different stocks.

28. A method of sequencing offers to one of buy or sell equities, the method for use in a network comprising a primary token loop including a primary source and primary receivers distributed intercontinentally, the method comprising the steps at said primary source of receiving credentials from an offering source that said offering source one of owns the equities or possesses the funds to obtain equities to be bought and of periodically passing a token around said primary token loop, one of said offers to buy or sell equities having no greater access to a trading floor than another.

29. A reformation server for use in a timed reliable multicast protocol network coupled to a local multicast protocol network, the reformation server for determining, responsive to a failed receiver of said timed reliable multicast protocol network, that said receiver has failed and reforming a token loop wherein tokens are passed periodically excluding said failed receiver.

30. A reformation server as recited in claim 29 wherein the reformation server notifies a previous operating receiver logically connected to said failed receiver to pass a token to a next logically connected operating receiver.
